(19) United States
(12) Patent Application Publication
(10) Pub. No.: US 2007/0150670 A1
(43) Pub. Date: Jun. 28, 2007

(54) Semiconductor integrated circuit

(75) Inventor: Hiroshi Tanaka, Kokubunji (JP)

Correspondence Address: MILES & STOCKBRIDGE PC, 1751 PINNACLE DRIVE, SUITE 500, MCLEAN, VA, 22102-3833, US

(73) Assignee: Hitachi, Ltd.

(21) Appl. No.: 11/642,888

(22) Filed: Dec. 21, 2006

(30) Foreign Application Priority Data
Dec. 26, 2005 (JP) 2005-371292

(51) Int. Cl. G06F 12/14

(52) U.S. Cl. 711/152

(57) ABSTRACT

When a semiconductor integrated circuit is constituted to include a plurality of processors and a module which can be accessed by the processors, there is provided a processor managing unit (PMU) capable of changing a utilizing permission of the other processors or the module which is given to the processor into the other processors. Consequently, it is possible to ease a management of the processors and the module. The processor managing unit can be disposed between a bus and a bus controller. Moreover, the processor managing unit can be distributed and disposed between the bus and the processors and between the bus and the module.

### CLAIM OF PRIORITY

The present application claims priority from Japanese application JP 2005-371292 filed on Dec. 26, 2005, the content of which is hereby incorporated by reference into this application.

### FIELD OF THE INVENTION

The present invention relates to a semiconductor integrated circuit, and furthermore, a technique for easing a management of a processor included therein and an IP (design property) module which can be accessed.

### BACKGROUND OF THE INVENTION

In recent years, a plurality of processors and IP modules have been provided on one semiconductor chip with a demand for a spread of an information processing apparatus, an increase in a performance and an enhancement in a function. In these chips, it is also possible to obtain a high performance at a low frequency by assigning a processing to the processors and the IP modules. A circuit scale which can be implemented by a semiconductor chip has been enlarged with the progress of a semiconductor manufacturing technique, and a semiconductor chip to effectively utilize a plurality of processors and IP modules has appeared. In these semiconductor chips, particularly, non-symmetrical multiprocessor chips for mounting a plurality of different processors thereon, a method of setting one core to be a master, thereby distributing a processing to other cores and controlling them or a method of independently operating each of them is used in most cases. There has been demanded a method of easily and effectively utilizing the processors and the IP modules which are mounted. Moreover, a plurality of programs is executed by a plurality of processors at the same time. For this reason, there has also been demanded a countermeasure for a security, for example, the prevention of the destruction of a program which is being executed by the other processor and the prevention of a peek into a memory region.

On the other hand, Patent Documents 1 and 2 have disclosed a hardware and method for managing a processor and a module such as an IP module and easily utilizing them, and using them effectively and practically.

In the related art, there has been presented a method of managing a module by a dedicated circuit or a software and drawing a performance. However, there has not been considered a hierarchical management which is important when a large number of processors are mounted, that is, an application, to the other processors, of a permission of utilization of a processor and an IP module which are permitted to be utilized for a certain processor itself. Moreover, the aspect of the security described above has not particularly been considered.

Patent Document 1: JP-A-2004-192052 Publication Patent Document 2: JP-A-2001-167058 Publication

### SUMMARY OF THE INVENTION

In the conventional methods described in the Patent Documents 1 and 2, a comparatively small number of processors and IP modules are supposed and a hierarchical management is not taken into consideration. Moreover, there is not particularly considered the case in which an unreliable program, particularly, such a program as to manage read/write of other processors and memories is executed.

In this case, it is necessary to solve the problem by an operating system or another software. There are supposed a complexity of a processing and a program and an increase in an overhead which is caused by a processing related thereto. Moreover, it is also supposed that the software cannot adequately correspond to the unreliable program.

In the future, a larger number of processors and IP modules will be mounted with an increase in a performance and an enhancement in a function of a built-in apparatus. For this reason, it is supposed that the problems become remarkable.

It is an object of the invention to provide a technique for easing a management of the processor and the module in a semiconductor integrated circuit on which a large number of processors and a module capable of being accessed by them are mounted.

It is another object of the invention to provide a technique for easily implementing a hierarchical management of a processor and an IP module and an access control of a memory region for each processor.

It is yet another object of the invention to provide a technique for easing a utilization of a semiconductor chip mounting a plurality of processors and IP modules thereon and reducing an overhead.

It is a further object of the invention to enhance a security in a utilization.

The above and other objects and novel features of the invention will be apparent from the description of the specification and the accompanying drawings.

The outlines of the representative examples of the invention disclosed herein, will be described briefly as follows.

When a semiconductor integrated circuit is constituted to include a plurality of processors and a module which can be accessed by the processors, there is provided a processor managing unit capable of changing a utilization permission of the other processors or the module which is given to the processors into the other processors.

According to the above-described representative example, the processor managing unit can change, into the other processes, the utilization permission of the other processors or the module which is given to the processors. This can achieve the easiness of the management of the processors and the module.

At this time, the semiconductor integrated circuit can include a bus for coupling the processors to the module, and the bus controller capable of controlling a data communication to be carried out through the bus. In that case, the processor managing unit can be disposed between the bus and the bus controller.

In the case in which there is included the bus for coupling the processors to the module, the processor managing unit can be distributed and disposed between the bus and the processors and between the bus and the module.

It is possible to provide a processor ID signal line capable of transmitting processor ID information for identifying each of the processors.

The processor managing unit can be constituted to include a storage portion capable of storing utilizing permission information of the other processors or the module for each of the processors, and a control logic for carrying out a control to change the utilizing permission of the other processors or the module which is given to the processors into the other processors based on the information stored in the storage portion.

Moreover, the processor managing unit can be constituted to include a storage portion capable of storing access permission information to a memory region in the other processors or the module for each of the processors, and a control logic for carrying out a control to change the access permission to the memory region in the other processors or the module which is given to the processors into the other processors based on the access permission information stored in the storage portion.

At this time, the storage portion can be constituted to include a first register indicating a control permission and a utilizing situation of the processor and a second register indicating a permitting situation of read and write for a memory region in the processor and a memory region in the module.

In that case, when second and third processors which are different from a first one of the processors are managed by the first processor, the first register is updated so that a relationship between the second processor and the third processor can be changed. In the case in which second and third processors which are different from the first one of the processors are managed by the first processor and a write permission to the second processor or the third processor is given, moreover, the second register is updated so that a relationship between the second processor and the third processor can be changed. By carrying out such a control, it is possible to hierarchically manage the processor and the module. The processor and the module can be managed hierarchically so that the easiness of the management of the processor and the module can be achieved, and furthermore, an overhead in a utilization can be reduced. By the management of the processor and the module, furthermore, it is possible to prevent the reference and destruction of data based on an unauthorized program.

### BRIEF DESCRIPTION OF THE DRAWINGS

FIG. 1 is a block diagram showing an example of a structure of a microprocessor according to an example of a semiconductor integrated circuit in accordance with the invention,

FIG. 2 is a diagram for explaining a register PECMLR included in a processor managing unit in the microcomputer,

FIG. 3 is a diagram for explaining a register MRWMR included in the processor managing unit in the microcomputer,

FIG. 4 is a flowchart showing an access control operation to an address region managed based on the register PECMLR,

FIG. 5 is a flowchart showing an access control operation to an address region managed based on the register MRWMR,

FIG. 6 is a flowchart showing the case in which the register PECMLR is updated,

FIG. 7 is a flowchart showing the case in which the register MRWMR is updated,

FIG. 8 is a flowchart showing a utilizing procedure in the case in which processor PE-B is utilized by processor PE-A in the microcomputer,

FIG. 9 is a diagram for explaining an example of a utilization of a processor and an IP module which are included in the microcomputer,

FIG. 10 is a diagram for explaining a communication utilizing the microcomputer, and

FIG. 11 is a block diagram showing another example of the structure of the microcomputer.

### DETAILED DESCRIPTION OF THE PREFERRED EMBODIMENTS

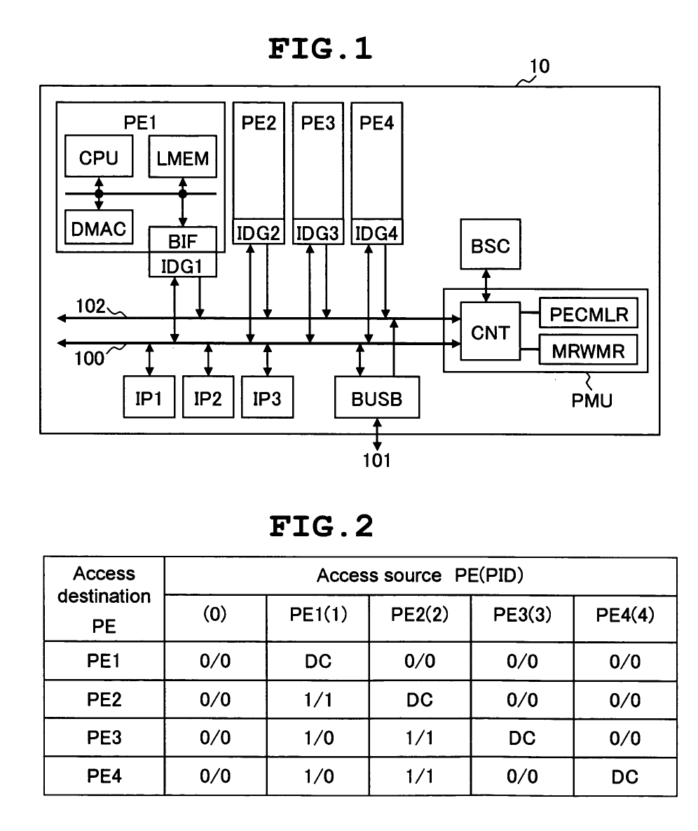

FIG. 1 shows a microprocessor according to an example of a semiconductor integrated circuit in accordance with the invention.

A microprocessor 10 shown in FIG. 1 is not particularly restricted but includes four processors PE1 to PE4, three IP modules IP1 to IP3, a bus bridge BUSB, a processor managing unit PMU, a bus state controller BSC, ID gates IDG1 to IDG4, an interprocessor bus 100, an external bus 101 and a processor ID signal line 102, and is formed on a semiconductor substrate such as a single crystal silicon substrate.

The processors PE1 to PE4 carry out a calculation processing in accordance with a preset program. The processors PE1 to PE4 are not particularly restricted but have identical structures to each other. The processor PE1 includes a central processing unit CPU, a local memory LMEM, a direct memory access controller DMAC, and a bus interface BIF. The central processing unit CPU carries out a calculation in accordance with an instruction. The local memory LMEM mainly stores data and a program which are to be utilized for the calculation in the processor PE1. An access can also be given from the outside of the processor PE1. The direct memory access controller DMAC is a module for transferring data without utilizing the central processing unit CPU. The bus interface BIF is an interface for connecting a bus in the processor to the ID gate IDG.

The IP modules IP1 to IP3 are set to be calculators having uses restricted, for example, a network interface, an input/output module such as a serial input/output, an audio dedicated circuit and a video processing dedicated circuit.

The bus bridge BUSB is a module for connecting the interprocessor bus 100 to the external bus 101. A bus protocol conversion and a timing regulation in the case in which an operating clock is varied are carried out. The BUSB supports both a communication from the interprocessor bus 100 to the external bus 101 and a communication from the external bus 101 to the interprocessor bus 100.

The interprocessor bus 100 is a general bus constituted to include a command line, an address line, a data line, a bus access request signal line, a bus access permission signal line, and an error signal line. The command line is used for transmitting an instruction for a communication to be carried out. More specifically, a selection of read or write and a size of data to be transferred are specified by a command transmitted through the command line. The address line is used for transmitting an address signal of a communication to be carriedout. The data line isused for an actual data transfer.

The processor ID signal line 102 is used for transmitting a processor ID for identifying a bus access request source (which will be referred to as PID). The PID is usually added through the ID gates IDG1 to IDG4. In case of a bus access request source in which the ID gate is not present, the PID signal line 102 is set to be “0”.

The ID gates IDG1 to IDG4 are disposed in a connecting portion of a module for giving a request for utilizing the interprocessor bus 100 and the interprocessor bus 100. In the example, they are disposed between the bus interface BIF in each processor and the interprocessor bus 100. Upon receipt of an access request given from an inner part of the processor to the interprocessor bus 100, the ID gates IDG1 to IDG4 add a signal of PID to the PID signal line 102 and output an access request to the interprocessor bus 100. PID for identifying each of the ID gates IDG1 to IDG4 is allocated thereto. In the example, PID of the processor PE1 is set to be “1”, PID of the processor PE2 is set to be “2”, PID of the processor PE3 is set to be “3”, and PID of the processor PE4 is set to be “4”. Moreover, the bus bridge BUSB can give an access request to the interprocessor bus 100. However, a corresponding ID gate IDG is not provided. In such a case, PID is set to be “0”.

The processor managing unit PMU includes registers PECMLR and MRWMR and a control logic CNT. The control logic CNT receives access requests from the PID signal line 102 and the interprocessor bus 100, and decides whether the access is permitted or not in accordance with the setting of the registers PECMLR and MRWMR.

It is also possible to provide a register MDR (not shown) for defining a mater processor capable of giving all accesses to the two registers PECMLR and MRWMR. In the case in which the register MDR is included, the smallest PID other than “0”, that is, “1” in the structure is set to the register MDR in a reset. Consequently, it is possible to carry out succeeding setting operations in accordance with a starting program to be executed in the processor PE1 corresponding to the PID1. Values of the other registers in the reset indicate that the access is not permitted.

In the case in which it is decided that the access is permitted by the processor managing unit PMU, a notice of a request is given to BSC. If the permission is not carried out, an error is returned to a request source from an error signal line of the interprocessor bus 100. In order to carry out the management of the bus access by PMU, it is also possible to apply existing BSC which corresponds to the interprocessor bus 100.

The bus state controller BSC carries out a utilization management of the interprocessor bus 100 in accordance with a signal output from PMU. A connection between the processor managing unit PMU and BSC is carried out with the same structure as the interprocessor bus 100.

FIG. 2 shows information stored in the register PECMLR in the processor managing unit PMU.

In FIG. 2, a first column from left indicates an access destination processor and a second row from top in second to sixth columns from left indicates an access source processor. A value in parentheses of the access source processor is PID assigned to the processor. In FIG. 2, items in the second to sixth columns from left and third to sixth rows from top indicate processor information. In the processor information, whether the access source processor can utilize the access destination processor is indicated on a left side of “/” and a right side of “/” indicates which processor utilizes the processor, and two sets are indicated in one item. “The access source processor can utilize the access destination processor” implies that the access source processor can execute an optional program by the access destination processor, and 1 denotes “utilizable” and 0 denotes “non-utilizable”. Moreover, “which processor utilizes the processor” implies which access source processor gives a request for executing a program by the access destination processor, and “1” denotes “utilized” and “0” denotes “unutilized”. In the case in which the access source processor and the access destination processor are identical to each other, an access can be given without carrying out the setting through the register. In the register, therefore, DC (Don't Care) represents that a control is not carried out, and write and read always return values which imply “impossible” and “DC”, respectively.

In the drawing, the access destination processor does not include BUSB. Such a structure is employed because BUSB is not a processor and cannot execute a program. In the case in which the setting in BUSB is to be treated in the same manner, the access destination processor can also include BUSB.

For example, in FIG. 2, in a column of the access source processor PE1 (PID1), the processor PE2 is set to be “1/1” indicating that it can be utilized by the processor PE1 and is executing a program requested from the processor PE1, and the processors PE3 and PE4 are set to be “1/0” indicating that they can be utilized by the processor PE1 and are not executing the program requested from the processor PE1. In a column of the access source processor PE2 (PID2) in FIG. 2, moreover, there is set “1/1” indicating that the processors PE3 and PE4 can be utilized by the processor PE2 and both of the processors PE3 and PE4 are executing a program requested from the processor PE2. The other processors PE3, PE4 and the module to which PID0 is assigned indicate a state in which “0/0” is set such that the other processors cannot be utilized.

Referring to an operation in the reset, the reset to “0” is wholly carried out in a structure including a register MDR (not shown) for defining a master processor. In the case in which the register MDR for defining the master processor is not included, all of the columns of the access source processor PE1 (PID1) having the smallest PID which is equal to or greater than PID0 are set to be “1/0” and the other values are set to be “0”. Consequently, all of the processors can be utilized by the processor PE1 through the reset.

With a structure including the register MDR (not shown) for defining the master processor, a processor set to be the MDR in an optional timing and state can change setting for an optional processor. Therefore, it is possible to forcibly utilize a certain processor and to reset a frozen processor. In the structure which does not include the register MDR, this respect can be covered by an application of a method of setting the register PECMLR.

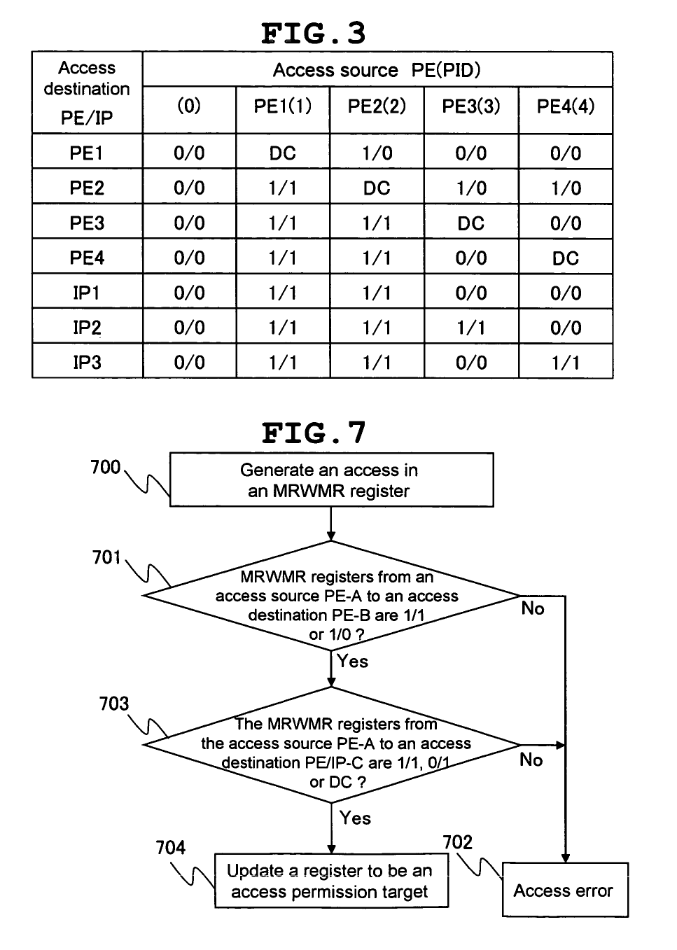

FIG. 3 shows information stored in the register MRWMR in the processor managing unit PMU. In FIG. 3, a first column from left indicates an access destination processor and two rows from top in second to sixth columns from left indicate an access source processor. A value in parentheses of the access source processor is PID assigned to the processor. Referring to items in third to ninth rows from top in the second to sixth columns from left in a table, a left side of “/” represents a permitting state of a read request from the access source processor to the access destination processor and a right side of “/” represents a permitting state of a write request from the access source processor to the access destination processor. In FIG. 3, “1” indicates “accessible” and “0” indicates “inaccessible”. In the case in which the access source processor and the access destination processor are identical to each other, an access can be given without carrying out the setting through the register. In the register, therefore, DC (Don't Care) represents that a control is not carried out, and write and read always return values which imply “impossible” and “DC”, respectively.

For example, in FIG. 3, referring to the column of the access source processor PE1 (PID1), an access to the processor PE2 and the IP modules IP1 to IP3 is set to be “1/1” indicating that read/write can be carried out, and an access to the processors PE3 and PE4 is set to be “1/0” indicating that only read can be carried out.

Referring to an operation in the reset, with the structure including the register MDR (not shown) for defining a master processor, a reset to “0” is wholly carried out. In the case in which the register MDR (not shown) for defining the master processor is not included, all of the columns of the access source processor PE1 (PID1) having the smallest PID are set to be “1/1” and the other values are set to be “0”. Consequently, all of the processors can be utilized by the processor PE1 through the reset.

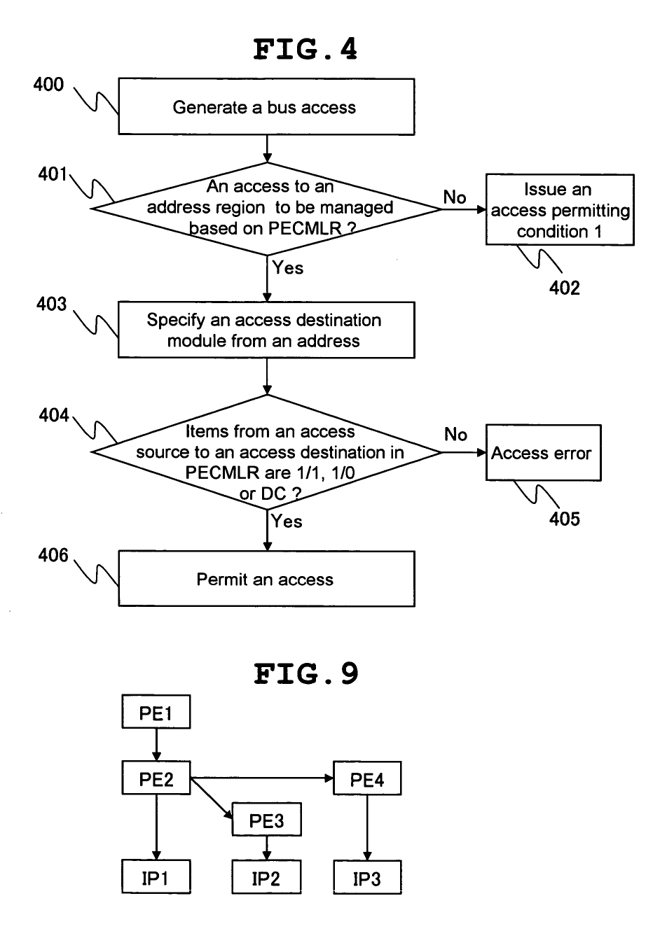

FIG. 4 shows a flow of an access control to an address region to be managed based on the register PECMLR indicative of a control permission and a utilizing situation of the processor illustrated in FIG. 2. The control is carried out by the control logic CNT. “An address region to be managed based on the register PECMLR” indicates a region in which a control register for utilizing each processor from an outside is disposed.

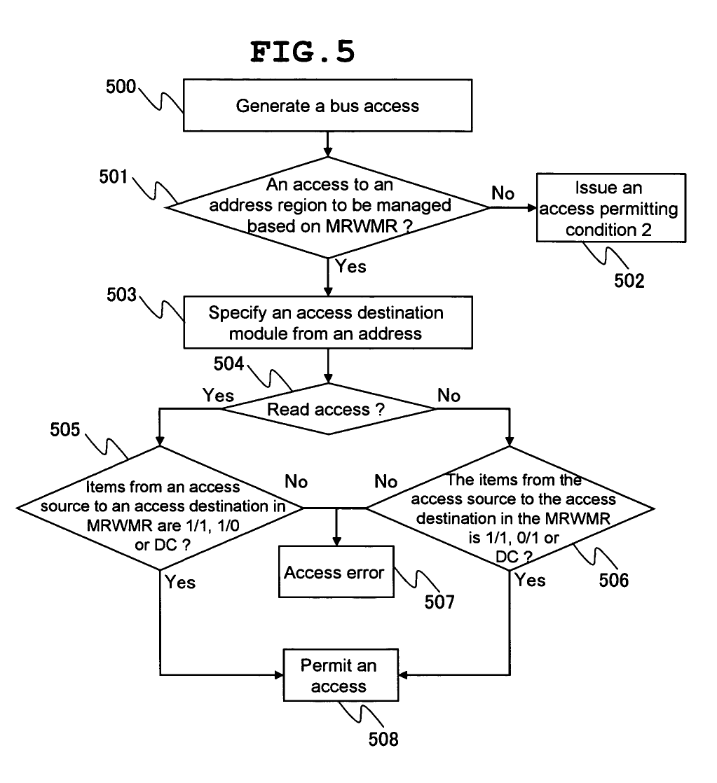

When a bus access is generated (400), it becomes a trigger to refer to an address of the bus access so that it is decided whether an access is given to the address region to be managed by the register PECMLR or not (401). In the decision, if it is decided that the access is given to the address region to be managed by the register PECMLR (Yes), an access destination module is specified by an address (403). In the decision of the Step S401, if it is decided that the access is not given to the address region to be managed by the register PECMLR (No), an access permitting condition 1 is issued. If both the access permitting condition 1 which is issued here in the step 402 of FIG. 4 and an access permitting condition 2 issued in the operation of FIG. 5 are completed, a bus access is permitted. In this case, the bus access is given to the outside of the memory region managed by the processor managing unit PMU, and a memory region assigned to an external bus in the example.

At the Step 403, an access destination module is specified from an address of an access destination specified by the bus access. In the example, any of the processors PE1 to PE4 is specified.

Next, reference is made to the register PECMLR, and it is decided whether a value of an item in which a module related to the generation of the bus access is set to be an access source processor and the access destination module specified at the Step 403 is “1/1”, “1/0” or “DC”. If it is decided that the value of the item is “1/1”, “1/0” or “DC” (Yes), the bus access is permitted (406). In the decision of the Step S404, if it is decided that the value of the item is not “1/1”, “1/0” or “DC” (No), an access error is set (405). More specifically, it is decided that an access is given to a region which is not permitted. Therefore, the access error is returned to a bus access generating source. If the bus access is permitted, a communication between the modules can be carried out through the interprocessor bus 100. By such a control, an access can be prevented from being given to the processor to which the access is not permitted to be given, a processor can be occupied to carry out a processing, and the control of the processor can be prevented from being taken away due to an unauthorized program.

FIG. 5 shows a flow of an access control to an address region to be managed based on the register MRWMR indicative of a control permission and a utilizing situation of the processor illustrated in FIG. 3. The control is carried out by the control logic CNT.

An address region to be managed based on the register MRWMR indicates internal memory regions of each of the processors and the IP module and does not overlap with the address region to be managed based on the register PECMLR.

When a bus access is generated (500), it becomes a trigger to refer to an address of the bus access so that it is decided whether an access is given to the address region to be managed based on the register MRWMR or not (501). In the decision, if it is decided that the access is given to the address region to be managed based on the register MRWMR (Yes), an access destination module is specified by an address (503). In the decision of the Step 501, if it is decided that the access is not given to the address region to be managed based on the register MRWMR (No), an access permitting condition 2 is issued (502). If both the access permitting condition 2 which is issued here in the step 502 of FIG. 5 and the access permitting condition 1 issued in the operation of FIG. 4 are completed, a bus access is permitted. In this case, the bus access is given to the outside of the memory region managed by the processor managing unit PMU, and a memory region assigned to an external bus in the example.

At the Step 503, moreover, an access destination module is specified from an address of an access destination specified by the bus access. In the example, any of the processors PE1 to PE4 and IP1 to IP3 is specified.

Next, reference is made to an instruction of the bus access and it is decided whether a read access is given or not. The decision whether a read access is given is equivalent to the decision whether a read access or a write access is given. In the decision, it is decided that the read access is given (Yes), reference is made to the register MRWMR and it is decided whether a value of an item in which a module generating a bus access is set to be an access source processor and the module specified at the Step 503 is set to be an access destination PE/IP is “1/1”, “1/0” or “DC” (505). In the decision, if it is decided that the value is “1/1”, “1/0” or “DC” (Yes), an access is permitted so that a communication between the modules can be carried out (508). If it is decided that the value is not “1/1”, “1/0” or “DC” in the decision of the Step 505 (No), however, an access error is returned to the module to be a bus access generating source (507). If it is decided that a read access is not given in the decision of the Step 504 (No), moreover, reference is made to the register MRWMR and it is decided whether a value of an item in which the module related to the bus access is set to be the access source processor and the module specified at the Step 503 is set to be the access destination PE/IP is “1/1”, “0/1” or “DC” (506). In the decision, if it is decided that the value is “1/1”, “0/1” or “DC” (Yes), an access is permitted so that a communication between the modules can be carried out (508). If it is decided that the value is not “1/1”, “0/1” or “DC” in the decision of the Step 506 (No), however, an access error is returned to the module to be the bus access generating source (507). By such a control, it is possible to prevent an access from being given to a module to which an access is not permitted to be given and to inhibit data from being referred to and falsified by an unauthorized program or a bug. Moreover, the permission of the read and the write can be individually set. Therefore, it is also possible to carry out an application in which only reference can be made.

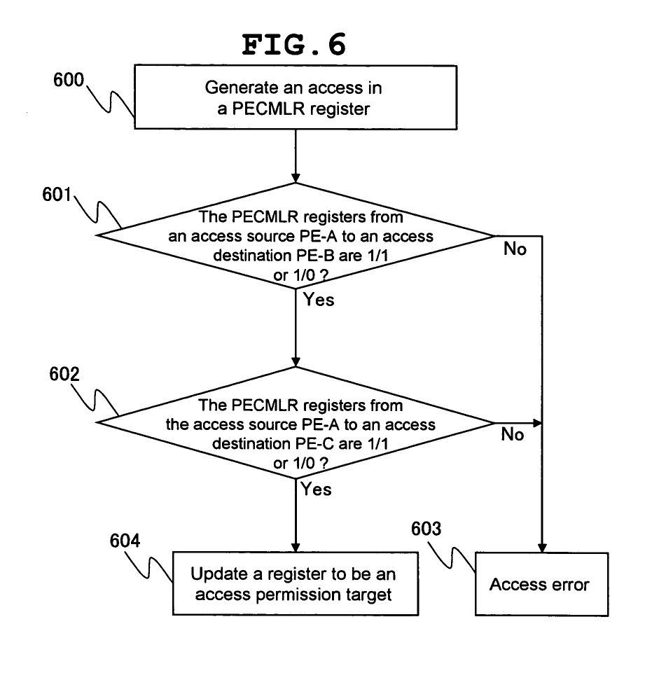

FIG. 6 shows a flow of an operation in the case in which the register PECMLR indicating a control permission and a utilizing situation of the processor illustrated in FIG. 2 is updated. The control is carried out by the control logic CNT. In FIG. 6, description is given by setting, as PE-A, PE-B and PE-C, a change request source processor, an access source processor in an item to be changed, and an access destination processor in the item to be changed, respectively.

First of all, an operation of the flowchart is started by setting, as a trigger, the generation of an access in the register PECMLR (600).

Reference is made to an item in which the access source processor is set to be PE-A and the access destination processor is set to be PE-B in the register PECMLR and it is decided whether “1/1” or “1/0” is set or not (601). In the decision, if it is decided that “1/1” or “1/0” is set (Yes), it is indicated that PE-B is managed by PE-A. If it is decided that “1/1” or “1/0” is set, reference is made to an item in which the access source processor is set to be PE-A and the access destination processor is set to be PE-C in the register PECMLR and it is decided whether “1/1” or “1/0” is set or not (602). In the decision, if it is decided that “1/1” or “1/0” is set (Yes), a register to be an access permitting object is updated (604). If it is decided that “1/1” or “1/0” is not set (No) in the decision of the Step 601 and “1/1” or “1/0” is not set (No) in the decision of the Step 602, an access error is set because an access is given to a region which is not permitted (603). By the operation, in the case in which the processors PE-B and PE-C are managed by the processor PE-A, it is possible to change a relationship between the processors PE-B and PE-C. Consequently, the processor PE-A can change the setting for only the processors which are managed. Thus, it is possible to carry out a hierarchical management of the processor. When the number of the processors to be loaded is increased, it is hard to grasp the management of all of the processors. By carrying out the hierarchical management, therefore, it is possible to ease the management.

FIG. 7 is a flowchart showing an operation in the case in which the register MRWMR for permitting the read and the write of a memory in the processor and a memory in the IP module (including a register subjected to memory mapping) illustrated in FIG. 3 is updated. In FIG. 7, description is given by setting, as PE-A, PE-B and PE/IP-C, a change request source processor, an access source processor in an item to be changed, and an access destination PE/IP in the item to be changed, respectively.

An operation of the flowchart is started by setting, as a trigger, the generation of an access in the register MRWMR (700). At Step 701, reference is made to an item in which the access source processor and the access destination processor in the register MRWMR are set to be PE-A and PE-B respectively, and it is decided whether 1/1 or 1/0 is set or not. If 1/1 or 1/0 is set, it is indicated that PE-B is managed by PE-A. If 1/1 or 1/0 is set, the processing proceeds to 703. If not so, the processing proceeds to Step 702. At the Step 702, it is decided that an access is given to a region which is not permitted. Therefore, an access error is returned to a module to be a bus access generating source. At the Step 703, reference is made to an item in which the access source processor and the access destination PE/IP in the register MRWMR are set to be PE-A and PE/IP-C respectively, and it is decided whether “1/1”, “0/1” or “DC” is set or not. If “1/1”, “0/1” or “DC” is set (Yes) in the decision, the processing proceeds to Step 704. If not so, the processing proceeds to the Step 702. At the Step 704, an access to the register MRWMR is permitted. Therefore, a target register is updated. In the case in which the processors PE-B and PE/IP-C are managed by the processor PE-A and a write permission is given to the processor PE-B or PE/IP-C by the operation, it is possible to change a relationship between the processor PE-B and the processor PE/IP-C. Consequently, the processor PE-A can change the setting for only the processors or IP modules which are managed. Thus, it is possible to carry out a hierarchical management of the processor. When the number of the processors or IP modules to be loaded is increased, it is hard to grasp all of the modules. By carrying out the hierarchical management, therefore, it is possible to ease the management.

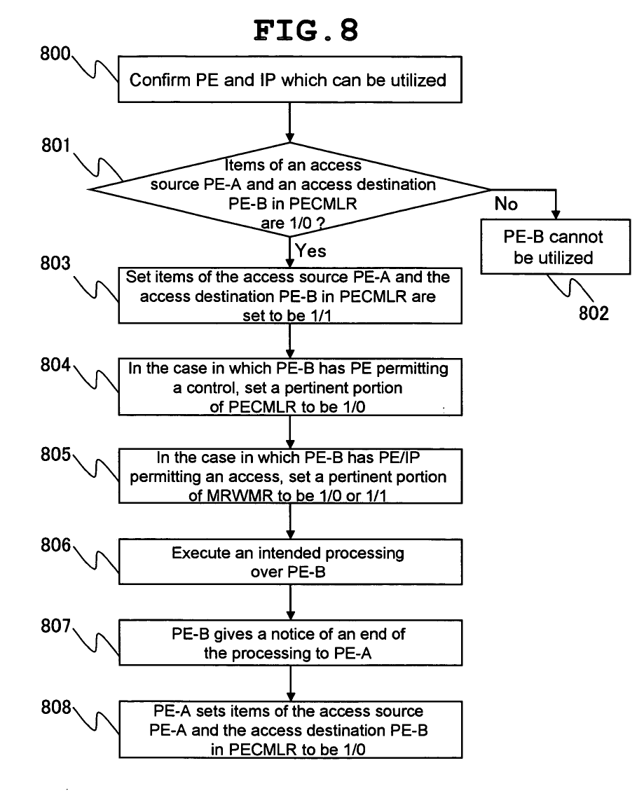

FIG. 8 shows a flow of a utilizing procedure in the case in which PE-B is utilized by PE-A.

At Step 800, PE-A confirms a processor and an IP module which can be utilized by PE-A. At Step 801, PE-A decides whether items for an access source processor A and an access destination processor B in PECMLR are 1/0 or not based on information obtained at 800. In the decision, if it is decided that the item is 1/0, it is decided that PE-B is managed by PE-A and is not currently utilized. Thus, the processing proceeds to Step 803. If the item is not 1/0, it is decided that PE-B is not managed by PE-A (0/0) or PE-B has already been utilized (1/1) so that the processing proceeds to Step 802. At the Step 802, PE-A cannot utilize PE-B. Therefore, the processing for the utilization of PE-B is ended. An operation for making an application for a utilizing permission of PE-B can also be supposed for PE having the management authority of PE-A, which is not particularly defined in the example. At the Step 803, PE-A sets the items for the access source processor A and the access destination processor B in PECMLR to be 1/1 and indicates that PE-B is being utilized by PE-A. At Step 804, if there is a processor for permitting PE-B to carry out a control, a pertinent place of the register PECMLR is set to be 1/0 and the control of PE-B is enabled. At Step 805, if there is PE/IP for permitting an access to PE-B, PE-A sets a pertinent place of the register MRWMR to be 1/0 or 1/1. A value to be set is varied depending on access permission contents to be given to PE-B. At Step 806, PE-A gives an access to the control register of PE-B, thereby causing PE-B to start an intended processing. At Step 807, when a processing requested from PE-A is completed, PE-B reports the completion of the processing to PE-A. At Step 808, PE-A sets the items for the access source processor A and the access destination processor B in PECMLR to be 1/0 and indicates that PE-B is not utilized by PE-A.

FIG. 9 shows an example of the utilization of the processors PE1 to PE4 and the IP modules IP1 to IP3 in the microcomputer 10 shown in FIG. 1.

An arrow in FIG. 9 indicates a relationship that one of the processors utilizes the other processors and a relationship that the IP module is utilized by one of the processors. More specifically, the processor PE2 is used by the processor PE1, the processors PE3, PE4 and IP1 are used by the processor PE2, the processor IP2 is used by the processor PE3, and the processor IP3 is used by the processor PE4. Based on the relationships, the register PECMLR which is executing the processing has the value shown in FIG. 2. Based on the relationships, moreover, the register MRWMR which is executing the processing has the value shown in FIG. 3.

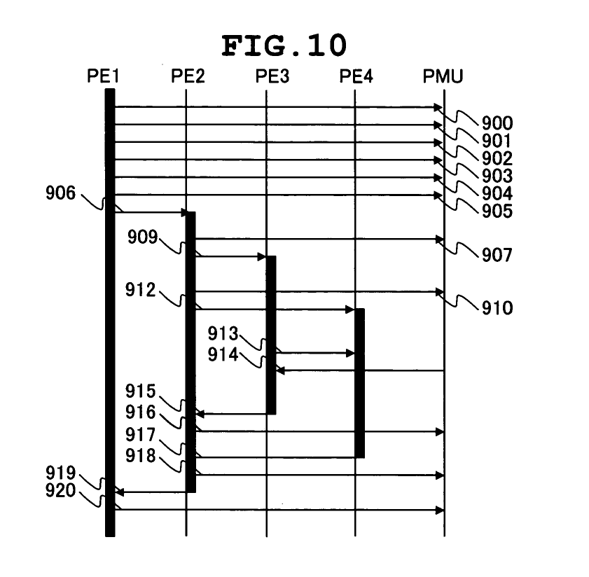

FIG. 10 shows an order of a communication in the case in which the microcomputer 10 is utilized in the relation shown in FIG. 9. In an initial state shown in FIG. 10, it is assumed that the processor PE1 is permitted to utilize all of the modules.

In FIG. 10, 900 to 906 indicate an operation for causing the processors PE1 and PE2 to execute a processing.

In 900, the registers PECMLRs of the access source processor 1 and the access destination processor 2 are set to be 1/1. In order to permit the processor PE2 to read a memory region of the processor PE1, moreover, the registers PECMLRs of the access source processor 2 and the access destination processor 1 are set to be 1/0.

In 901, in order to permit the processor PE2 to utilize the processor PE3, the registers PECMLRs of the access source processor 2 and the process destination processor 3 are set to be “1/0” and the register MRWMR is set to be “1/1”. In 902, in order to permit the processor PE2 to utilize the processor PE4, the registers PECMLRs of the access source processor 2 and the access destination processor 4 are set to be “1/0”. The register MRWMR is set to be “1/1”. In 903, in order to permit the processor PE2 to utilize IP1, the registers MRWMRs of the access source processor 2 and the access destination IP1 are set to be “1/1”. In 904, in order to permit the processor PE2 to utilize IP2, the registers MRWMRs of the access source processor 2 and the access destination IP2 are set to be “1/1”. In 905, in order to permit the processor PE2 to utilize IP3, the registers MRWMRs of the access source process 2 and the access destination IP3 are set to be “1/1”. In 906, the processor PE1 causes the processor PE2 to execute an intended processing. At this time, all of the processors PE3 and PE4 and IP modules IPl to IP3 can be maintained to be utilized by the processor PE2, and the processor PE2 can execute the given processing by utilizing these modules. 907 to 909 indicate an operation for causing the processor PE3 to execute a processing by the processor PE2.

In 907, in order to permit the processor PE3 to utilize IP2, the registers MRWMRs of the access source processor 3 and the access destination IP2 are set to be “1/1”. In 909, the processor PE2 causes the processor PE3 to execute an intended processing. At this time, IP2 can be maintained to be utilized by the processor PE3, and the processor PE3 can execute the given processing by utilizing the module. 910 to 912 indicate an operation for causing the processor PE4 to execute a processing by the processor PE2. In 910, in order to permit the processor PE4 to utilize IP3, the registers MRWMRs of the access source processor 4 and the access destination IP3 are set to be “1/1”. In 912, the processor PE2 causes the processor PE4 to execute an intended processing. At this time, IP3 can be maintained to be utilized by the processor PE4, and the processor PE4 can execute the given processing by utilizing the module. 913 and 914 indicate operations in the case in which an unpermitted access is given. Although an access is given from the processor PE3 in order to utilize the processor PE4 in 913, it is not permitted in a pertinent portion of the register PECMLR. For this reason, an error is sent from PMU in 914. Moreover, the values of the registers in FIGS. 2 and 3 indicate values in this state. In 915, since the processor PE3 ends the intended processing, it gives a notice of the end to the processor PE2 to be a processing request source. In 916, the notice of 915 is received and the values of the registers PECMLRs of the access source processor 2 and the access destination processor 3 are set to be 1/0 and are thus updated to be values indicating that the processing is not carried out. In 917, since the processor PE4 ends the intended processing, it gives a notice of the end to the processor PE2 to be the processing request source. In 918, a notice of 917 is received and the values of the registers PECMLRs of the access source processor 2 and the access destination processor 4 are set to be 1/0 and are thus updated to be values indicating that the processing is not carried out. In 919, since the processor PE2 ends the intended processing, it gives a notice of the end to the processor PE1 to be the processing request source. In 920, a notice of 919 is received and the values of the registers PECMLRs of the access source processor 1 and the access destination processor 2 are set to be 1/0 and are thus updated to be values indicating that the processing is not carried out.

As described above, by utilizing the microcomputer employing the structure according to the invention, it is possible to ease the management and to reduce an overhead in a utilization in a chip including a plurality of processors and IP modules. Moreover, it is also possible to prevent the reference and destruction of data due to an unauthorized program.

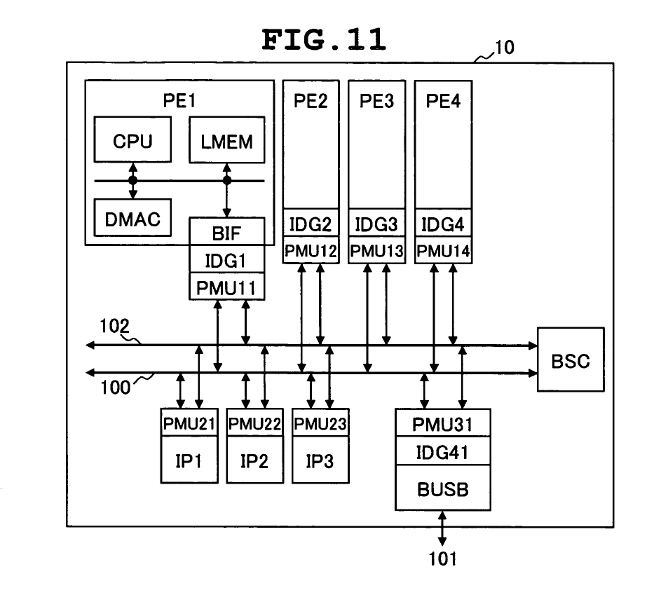

FIG. 11 shows another example of the structure of the microcomputer 10.

The microcomputer 10 shown in FIG. 11 is greatly different from that shown in FIG. 1 in that a processor managing unit PMU is disposed between processors PE1 to PE4 and IP modules IP1 to IP3, and an interprocessor bus 100 and a PID line 102. More specifically, a processor managing unit PMU 11 is disposed between an ID gate IDG1 and the interprocessor bus 100 and PID line 102, a processor managing unit PMU12 is disposed between an ID gate IDG2 and the interprocessor bus 100 and PID line 102, a processor managing unit PMU13 is disposed between an ID gate IDG3 and the interprocessor bus 100 and PID line 102, and a processor managing unit PMU14 is disposed between an ID gate IDG4 and the interprocessor bus 100 and PID line 102. A processor managing unit PMU21 is disposed between the IP module IP1 and the interprocessor bus 100 and PID line 102, a processor managing unit PMU22 is disposed between the IP module IP2 and the interprocessor bus 100 and PID line 102, a processor managing unit PMU23 is disposed between the IP module IP3 and the interprocessor bus 100 and PID line 102, and a processor managing unit PMU31 is disposed between an ID gate IDG41 and the interprocessor bus 100 and PID line 102. With a change in a position of PMU, a register in PMU is constituted to have each of the processors or IP modules which are connected in an access destination PE/IP. In he structure shown in FIG. 11, a distributed management is carried out differently from an integrated management in FIG. 1. By each processor managing unit, however, it is possible to obtain the same functions and advantages as those in he structure shown in FIG. 1.

In contrast to the structure shown in FIG. 1, it is necessary to change the modules when connecting the IP module and the processor PE in the structure. Therefore, it is expected that an area is also increased. However, there is an advantage that a decision can be carried out at a high speed because of a reduction in an address range to be decided by each PMU and a range of an address to be managed can be flexibly set by each module.

While the invention made by the inventor has been specifically described above, the invention is not restricted thereto but it is apparent that various changes can be made without departing from the scope thereof.

While the description has been given to the case in which the invention made by the inventor is mainly applied to a microprocessor to be a utilization field which is the background thereof, the invention is not restricted thereto but can be applied to various semiconductor integrated circuits. The invention can be applied on the condition that at least a plurality of processors is included.

What is claimed is:

1. A semiconductor integrated circuit comprising:
a plurality of processors;
a module capable of being accessed by the processors; and
a processor managing unit,
wherein the managing unit can change a utilizing permission of the other processors or the module which is given to the processors into the other processors.

2. The semiconductor integrated circuit according to claim 1, further comprising:
a bus for coupling the processors to the module; and
a bus controller capable of controlling a data communication to be carried out through the bus,
the processor managing unit being disposed between the bus and the bus controller.

3. The semiconductor integrated circuit according to claim 1, further comprising:
a bus for coupling the processors to the module,
the processor managing unit being distributed and disposed between the bus and the processors and between the bus and the module.

4. The semiconductor integrated circuit according to claim 1, further comprising a processor ID signal line capable of transmitting processor ID information for identifying each of the processors.

5. The semiconductor integrated circuit according to claim 1, wherein the processor managing unit includes a storage portion capable of storing utilizing permission information of the other processors or the module for each of the processors; and
a control logic for carrying out a control to change the utilizing permission of the other processors or the module which is given to the processor into the other processors based on the information stored in the storage portion.

6. The semiconductor integrated circuit according to claim 1, wherein the processor managing unit includes a storage portion capable of storing access permission information to a memory region in the other processors or the module for each of the processors; and
a control logic for carrying out a control to change the access permission to the memory region in the other processors or the module which is given to the processor into the other processors based on the access permission information stored in the storage portion.

7. The semiconductor integrated circuit according to claim 6, wherein the storage portion includes a first register indicating a control permission and a utilizing situation of the processor and a second register indicating a permitting situation of read and write for a memory region in the processor and a memory region in the module.

8. The semiconductor integrated circuit according to claim 7, wherein in the case in which second and third processors which are different from a first one of the processors are managed by the first processor respectively, the first register is updated so that a relationship between the second processor and the third processor can be changed.

9. The semiconductor integrated circuit according to claim 7, wherein in the case in which second and third processors which are different from a first one of the processors are managed by the first processor respectively and a write permission to the second processor or the third processor is given, the second register is updated so that a relationship between the second processor and the third processor can be changed.
